(19) United States
(12) Patent Application Publication
(10) Pub. No.: US 2025/0347443 A1
(43) Pub. Date: Nov. 13, 2025

(54) SYSTEM FOR BRACING A WATER HEATER

(71) Applicant: RTF Components LLC, San Carlos, CA (US)

(72) Inventor: Joshua Pierre Cottonaro, Belmont, CA (US)

(21) Appl. No.: 19/202,428

(22) Filed: May 8, 2025

Related U.S. Application Data
(60) Provisional application No. 63/644,682, filed on May 9, 2024.

(51) Int. Cl. F24H 9/06; F16B 2/08

(52) U.S. Cl. CPC F24H 9/06; F16B 2/08

(57) ABSTRACT

A method includes anchoring a mounting bracket to a wall near a water heater and securing a first end of a strap to the mounting bracket. The strap includes a slot between the first end and a distal second end. The strap is wrapped about a tank of the water heater so that the tank is between the strap and the mounting bracket, a base of an attachment bracket is between the strap and the tank, and a tab of the attachment bracket extends from the base and through the slot. A first threaded receiver is secured to the mounting bracket and a first end of a threaded shaft is secured to the first threaded receiver. A second end of the threaded shaft is inserted through the tab and a second threaded receiver is fastened along the threaded shaft to secure the tank between the strap and the mounting bracket.

### CROSS REFERENCE TO RELATED APPLICATION

The present application claims the filing benefits of U.S. provisional application Ser. No. 63/644,682, filed May 9, 2024, which is hereby incorporated herein by reference in its entirety.

### FIELD OF THE INVENTION

The present invention relates to a system for bracing a water heater to a vertical wall structure.

### BACKGROUND OF THE INVENTION

Many jurisdictions require water heaters in commercial and residential properties to be secured to a vertical wall structure to prevent the water heater from moving or tipping, such as during an earthquake. Movement of the water heater can sever or disconnect water and/or gas lines from the water heater, causing flooding or dangerous gas leaks. Thus, regulations may define required positioning of straps wrapped around the water heater and required dimensions for fasteners anchoring the straps to the wall. Often, these straps are secured directly to the wall or to wooden boards or blocks mounted to the wall, leading to misalignment and/or insufficient tightening of the straps and an inadequately secured water heater.

### SUMMARY OF THE INVENTION

A system for bracing a water heater to a vertical wall structure includes a mounting bracket configured to be anchored to a vertical wall structure, a strap that is secured to the mounting bracket, and a tightening mechanism that adjusts a tightness of the strap about the tank of the water heater. For example, a method of bracing the water heater to the vertical wall structure includes anchoring the mounting bracket to the vertical wall structure near the water heater. A first end of the strap is secured to the mounting bracket. The strap includes a second end distal from the first end. One or more slots are formed through the strap between the first end and the second end. The strap is wrapped at least partially about the tank of the water heater so that the tank is disposed between the strap and the mounting bracket. With the strap wrapped at least partially about the tank of the water heater, an attachment bracket is disposed between the strap and the tank of the water heater and a tab of the attachment bracket extends through one of the slots of the strap. A first threaded receiver is secured to the mounting bracket. With the strap wrapped at least partially about the tank of the water heater, and with the tab of the attachment bracket extending through the slot of the strap, and with a first end of a threaded shaft secured to the first threaded receiver at the mounting bracket, a second end of the threaded shaft is inserted through the tab of the attachment bracket. A second threaded receiver is fastened along the threaded shaft to secure the tank of the water heater between the strap and the mounting bracket. Further, adjusting the second threaded receiver along the threaded shaft tightens the strap about the tank of the water heater.

These and other objects, advantages, purposes and features of the present invention will become apparent upon review of the following specification in conjunction with the drawings.

### BRIEF DESCRIPTION OF THE DRAWINGS

FIG. 1 is a perspective view of a water heater and a system for bracing the water heater to a vertical wall structure;

FIG. 2 is an enlarged view of the water heater and the bracing system, where a mounting bracket of the bracing system is anchored to the wall and a strap of the bracing system is wrapped around a tank of the water heater and secured to the bracket;

FIGS. 3-13 are views of the bracing system;

FIGS. 14 and 15 are views of the mounting bracket;

FIGS. 16-18 are views of a tightening mechanism of the bracing system;

FIGS. 19-22 are views of the strap; and

FIG. 23 shows additional views of the bracing system with example dimensions.

### DESCRIPTION OF THE PREFERRED EMBODIMENTS

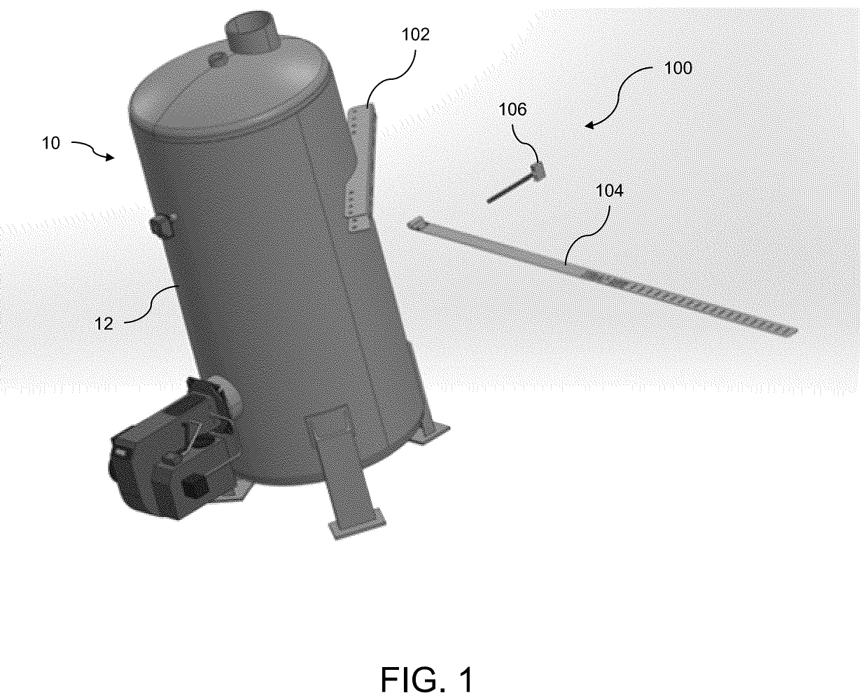

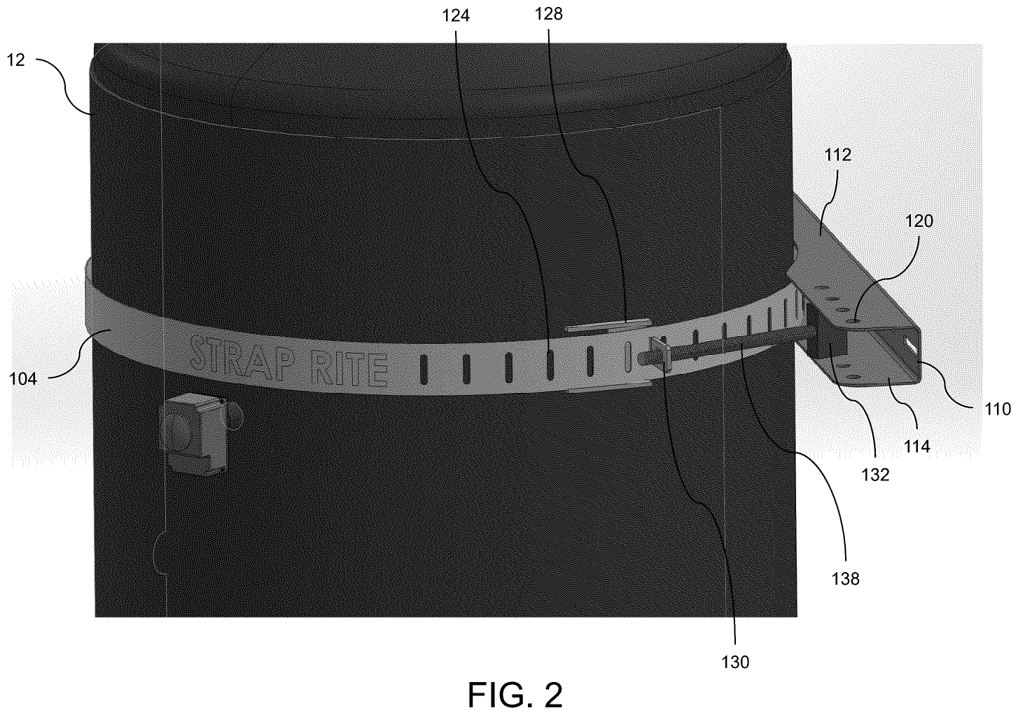

Referring now to the drawings and the illustrative embodiments depicted therein, a system 100 for bracing a water heater 10 to a vertical wall structure, such as a cinder block wall or a wooden framed wall, includes a mounting bracket 102 that anchors to the wall, a strap 104 that attaches to the bracket 102 and wraps at least partially around a tank 12 of the water heater 10, and a tightening mechanism 106 that tightens the strap 104 around the water heater 10 (FIGS. 1 and 2). As discussed further below, when the bracket 102 is anchored to the wall, the strap 104 is wrapped around the tank 12 of the water heater 10, and the tightening mechanism 106 is adjusted to secure the strap 104 around the tank 12, the system 100 braces the water heater 10 to comply with construction regulations in various jurisdictions. Further, the system 100 is adjustable to accommodate differently sized water heaters and different mounting configurations.

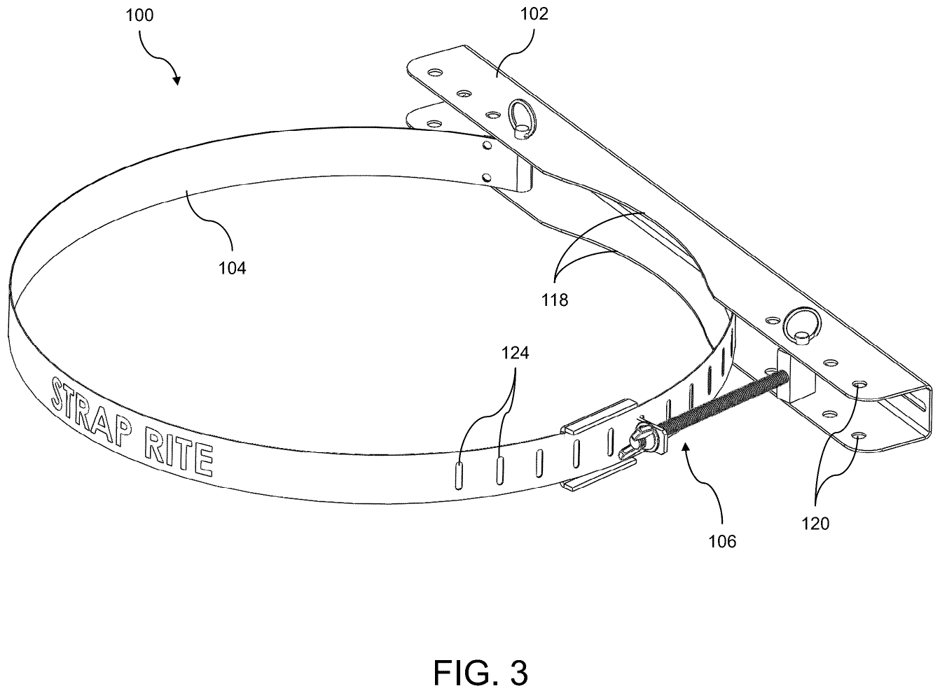

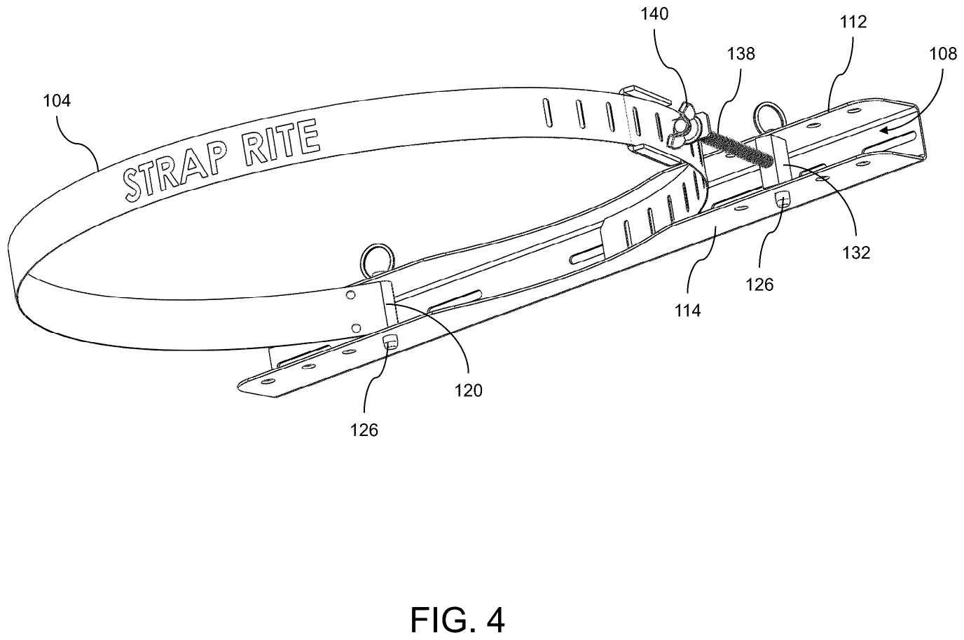

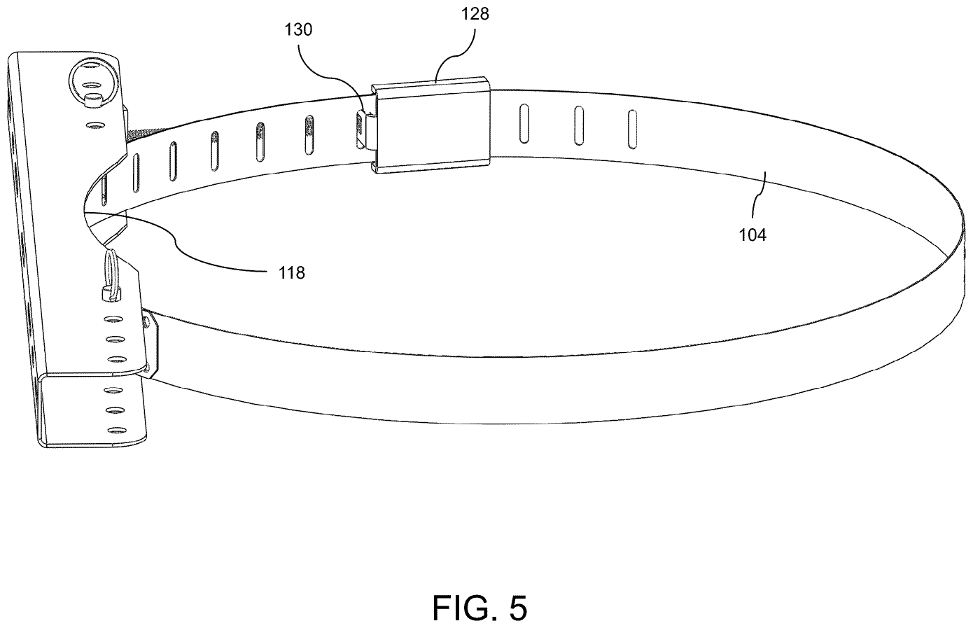

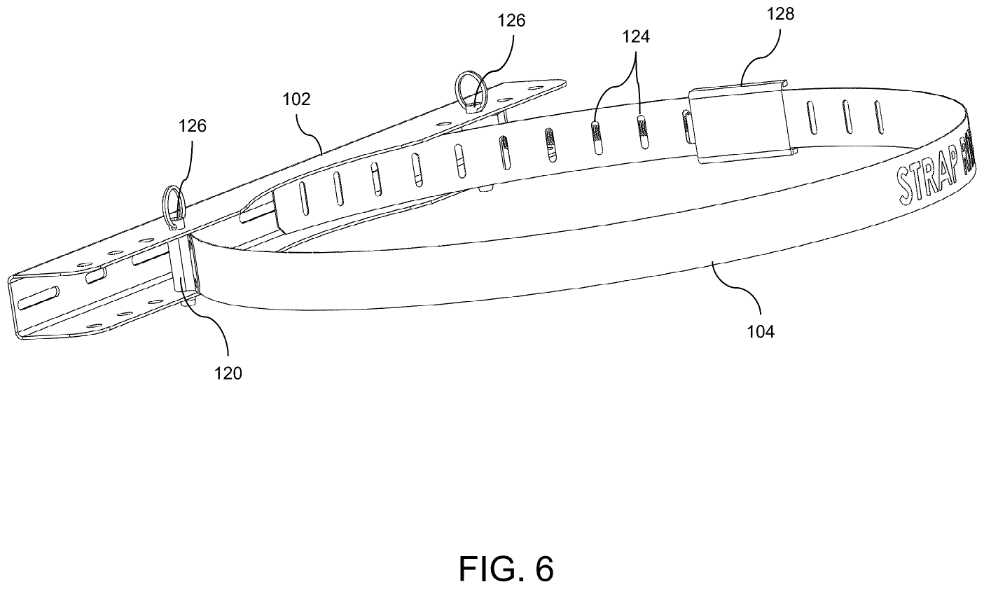

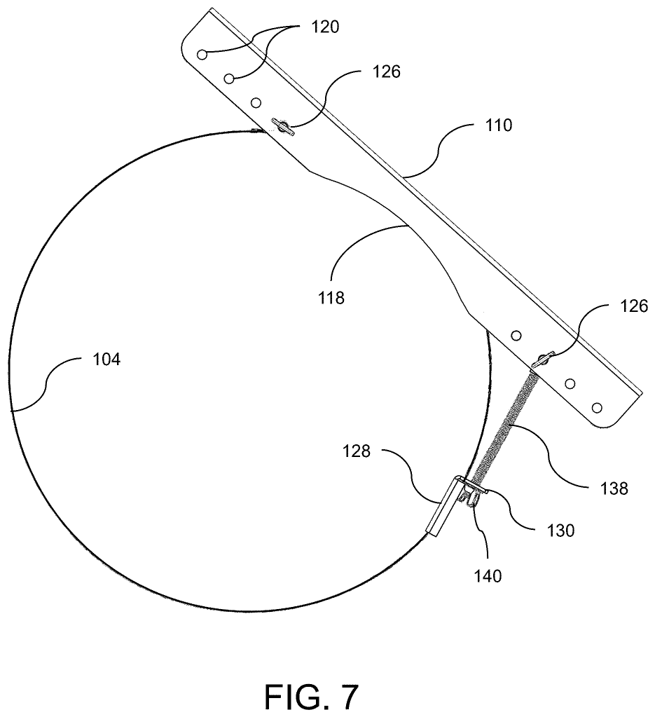

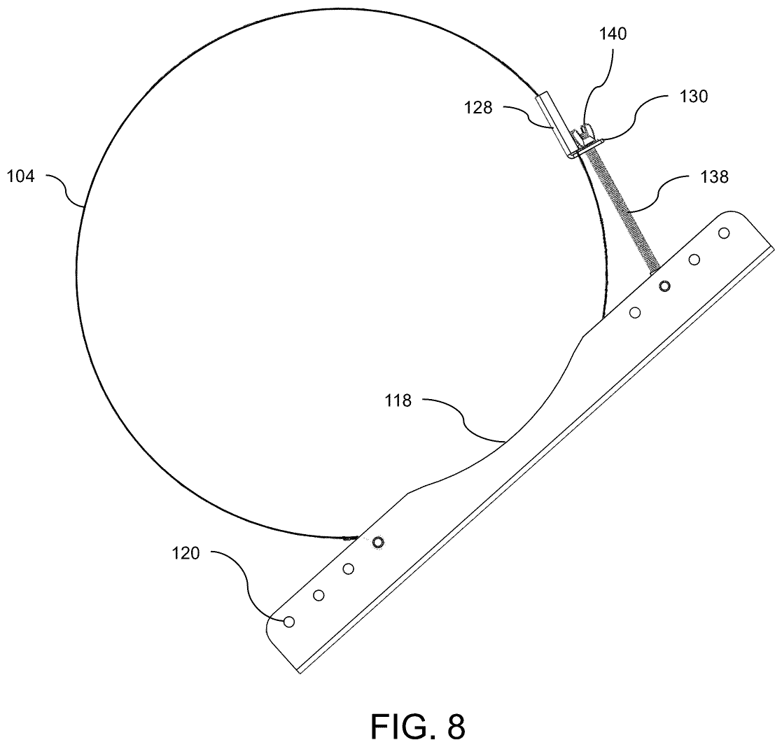

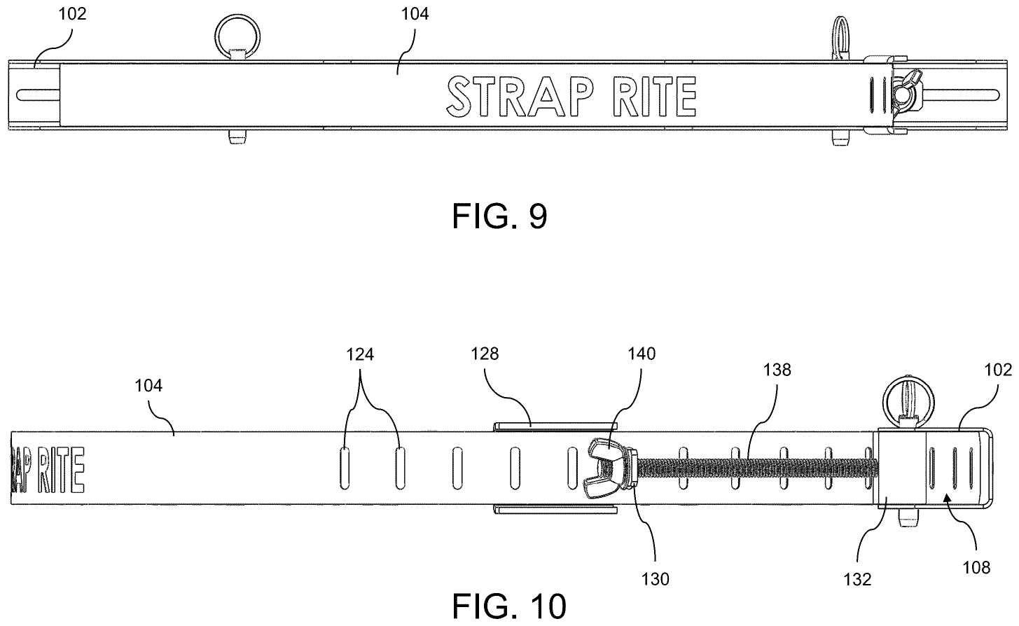

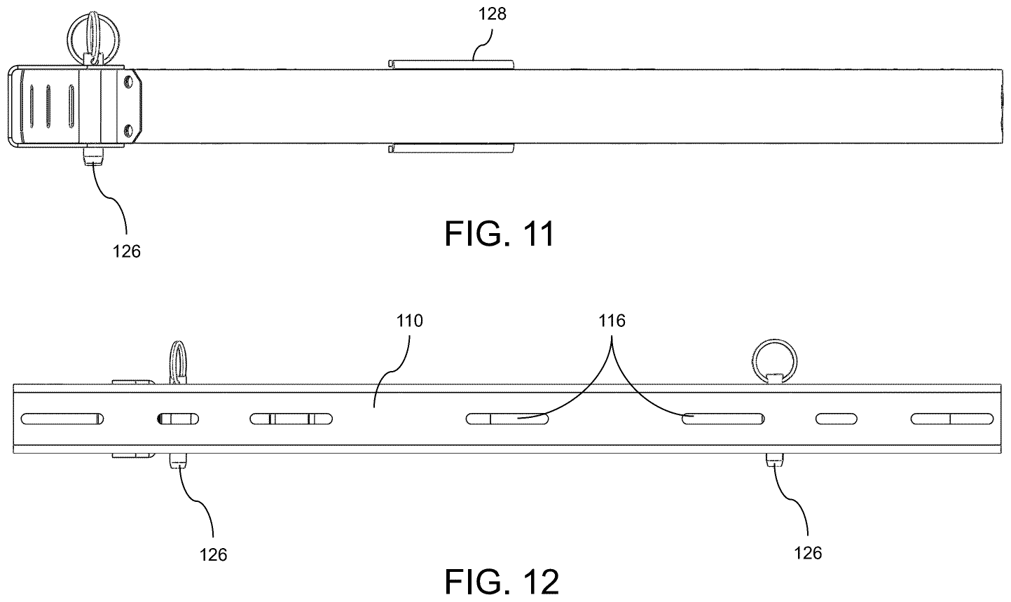

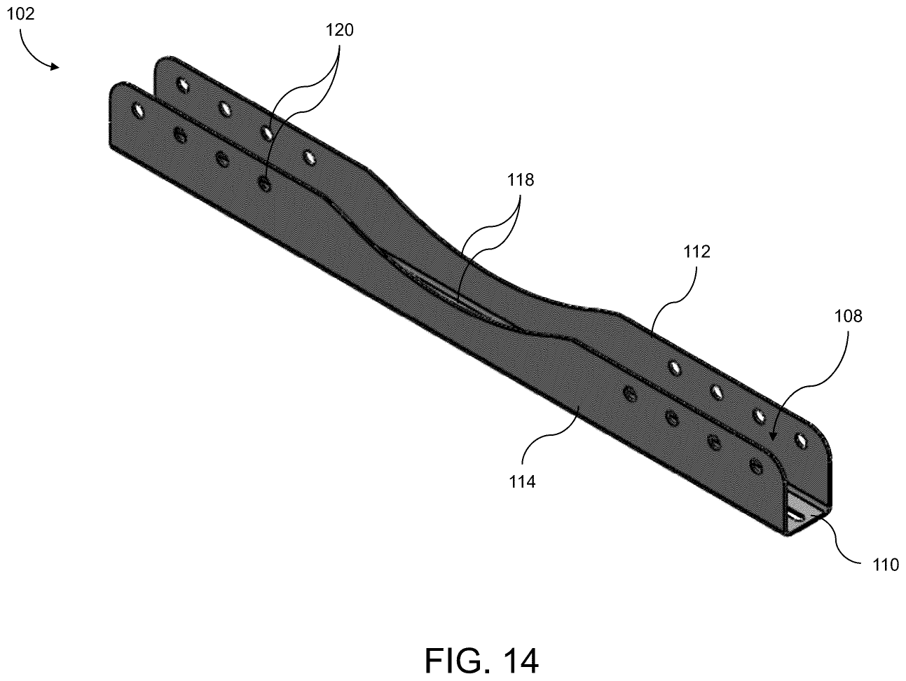

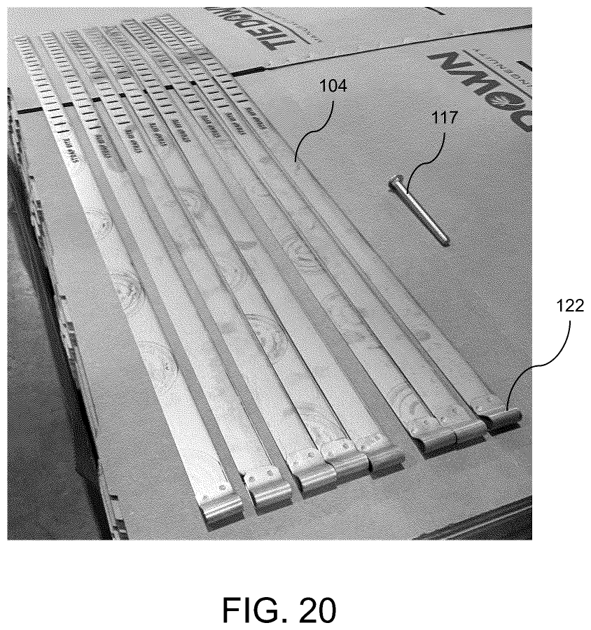

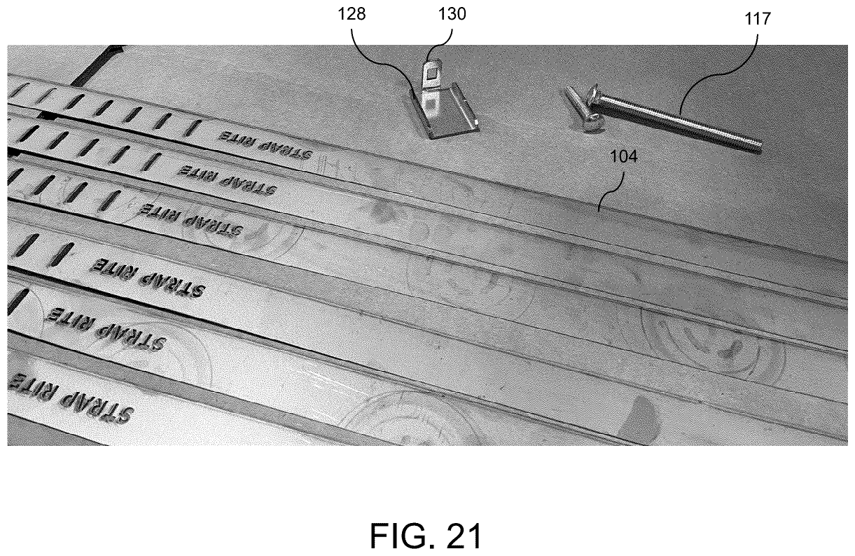

Referring to FIGS. 3-15, the mounting bracket 102 includes a substantially U-shaped rail defining a channel 108 extending between open ends of the mounting bracket 102. The rail may comprise a substantially square or flat-bottomed U-shape. The bracket 102 may be formed from any suitable material, such as 14 gauge aluminum. When the bracket 102 is anchored to the wall, a first wall or base 110 of the U-shaped rail engages and/or faces the wall, with a first or upper leg 112 and a second or lower leg 114 extending from the base 110 and away from the wall. Thus, when the bracket 102 is anchored to the wall, the open side of the channel 108 faces the water heater 10. A plurality of slots or through holes 116 are formed through the base 110 and configured to receive respective fasteners 117, such as threaded bolts or lag screws, for anchoring the mounting bracket 102 to the wall (FIGS. 20 and 21). The slots 116 may extend parallel to a longitudinal axis of the mounting bracket 102 to allow for horizontal movement of the bracket 102 relative to positions of the fasteners (e.g., at studs of the wall) during mounting of the bracket 102. This may allow for an offset between the mounting position of the bracket 102 (e.g., at studs of the wall) and the tank 12 of the water heater 10, meaning that the tank 12 does not need to be centered or precisely aligned with the mounting position of the bracket 102.

The first leg 112 and the second leg 114 may include respective recesses or cutouts 118 along the edges distal from the base 110, where the cutouts 118 are aligned with one another and have an arcuate or curved shape configured to accommodate the curvature of the tank 12. In other words, the cutout 118 of the bracket 102 conforms to the outer surface of the tank 12 when the bracket 102 is anchored to the wall between the water heater 10 and the wall. Dimensions of the bracket 102 may be configured to allow for required spacing between the water heater 10 and the wall. That is, regulations may require the water heater to be within, for example, two inches of the wall. The cutout 118 may reduce the width of the bracket 102 directly between the water heater 10 and the wall to comply with regulatory requirements.

Further, the first leg 112 and the second leg 114 include a plurality of pin holes 120 formed therethrough, with respective pin holes 120 at the first leg 112 aligned with respective pin holes 120 at the second leg 114. The pin holes 120 are configured to receive a pin or other suitable fastener, such as a threaded bolt, for attaching the strap 104 to the bracket 102.

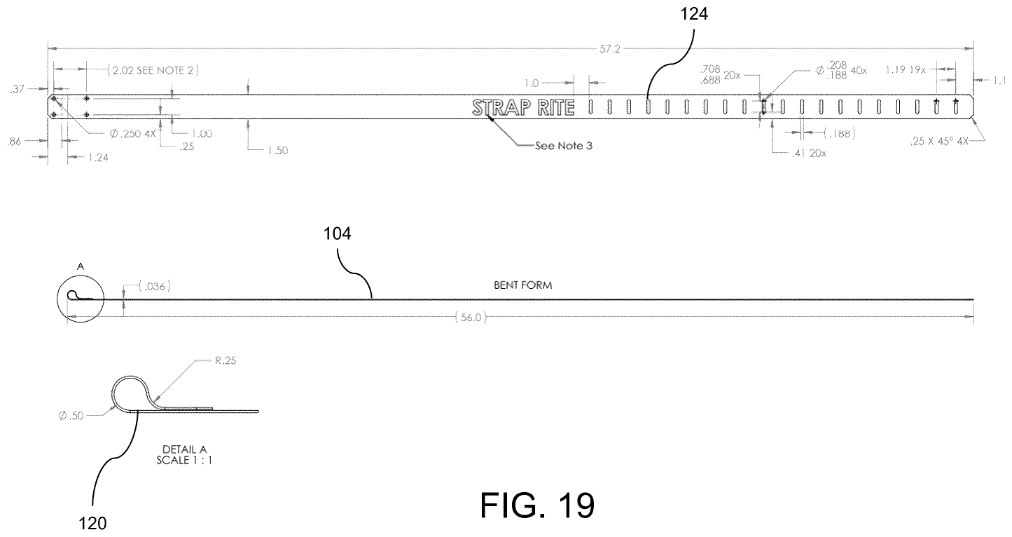

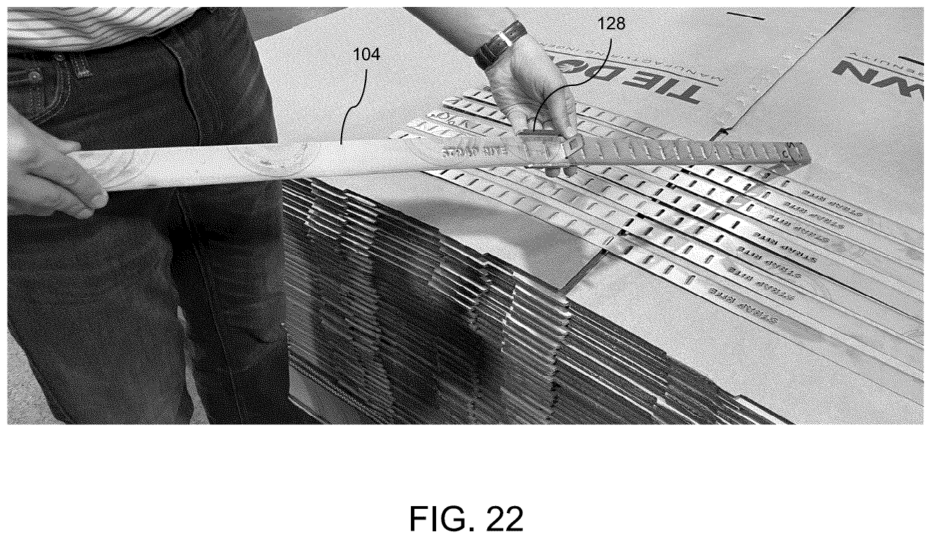

As shown in FIGS. 19-22, the strap 104 includes a flexible strip of material, such as 20 gauge sheet steel or the like, with a receiving portion 122 disposed at a first end of the strap 104. For example, the flexible strip may be doubled over and secured to itself (e.g., via welding or an adhesive material, or via a rivet or fastener extending through the two layers of the strap) so that a gap or channel between the two layers of the flexible strip forms the receiving portion 122. A plurality of slots or slits or through holes 124 are formed along the strap 104 and spaced from the receiving portion 122 to provide receivers for the tightening mechanism 106. In the illustrated example, the slots 124 are uniformly spaced from one another along a second end region of the strap 104.

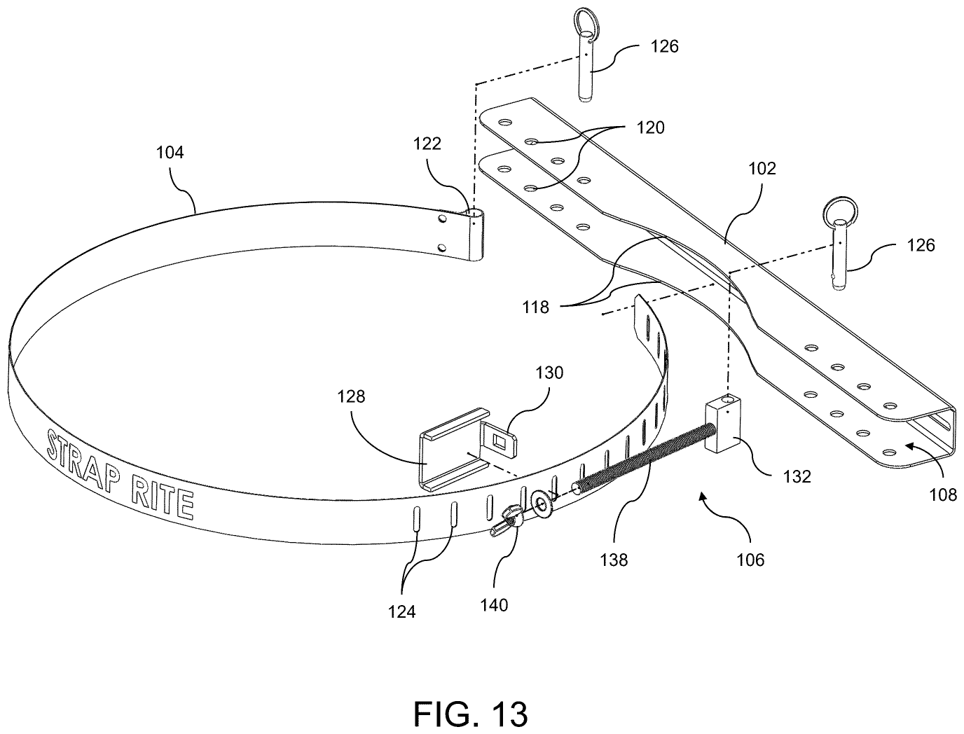

Referring to FIGS. 2 and 13, when the receiving portion 122 is disposed within the channel 108 of the bracket 102 and the channel of the receiving portion 122 is aligned with a pair of pin holes 120 of the mounting bracket 102, a fastener such as a quick release pin 126 may be inserted through the pin holes 120 and the receiving portion 122 to secure the first end of the strap 104 relative to the bracket 102. The first end of the strap 104 may be secured along a first side portion of the bracket 102 (e.g., at one side of the recess 118). Moreover, the first end of the strap 104 may be pivotable about the pin 126 to allow for manipulation of the strap 104 relative to the tank 12 of the water heater 10.

With the first end of the strap 104 secured relative to the bracket 102, the strap 104 is wrapped at least partially around the tank 12 of the water heater 10 and the second end region of the strap 104 is secured relative to a second side portion of the bracket 102 (e.g., at the other side of the recess 118). As shown, an attachment bracket 128 is disposed between the strap 104 and the tank 12 spaced from the mounting bracket 102 with a tab 130 of the attachment bracket 128 extending from the base of the attachment bracket 128 and through a selected one of the slots 124. The tightening mechanism 106 attaches between the attachment bracket 128 and the mounting bracket 102 to secure the second end region of the strap 104 relative to the mounting bracket 102.

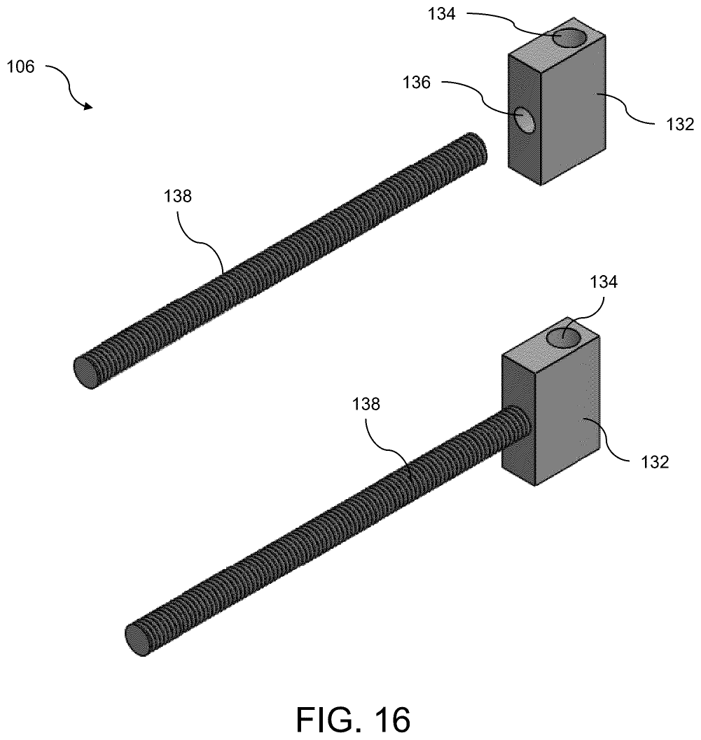

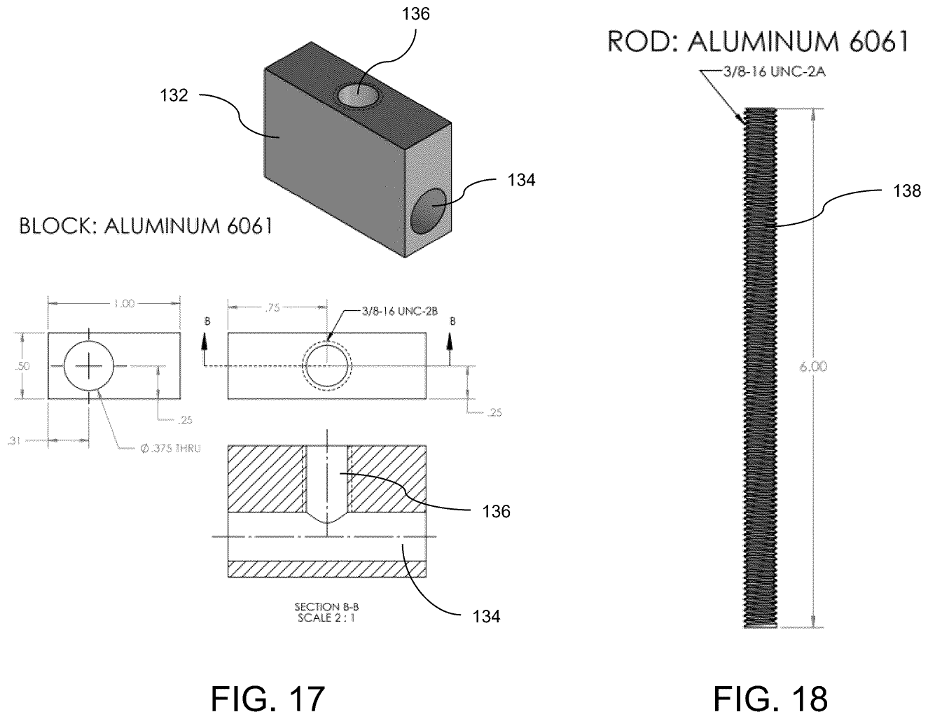

That is, the tightening mechanism 106 includes a receiving block 132 having a through hole or passageway 134 extending therethrough and a threaded receiver 136 extending transverse to and intersecting the passageway 134 (FIGS. 16-18). The receiving block 132 is received along the channel 108 of the mounting bracket 102 and, with the passageway 134 aligned with a pair of holes 120 of the mounting bracket 102, another fastener or quick release pin 126 is inserted through the holes 120 and the passageway 134 to secure the block 132 relative to the mounting bracket 102. A first end of a threaded shaft or fastener 138 is received along the threaded receiver 136 of the block 132 and a second end of the threaded shaft 138 is secured to the tab 130 of the attachment bracket 128 to secure the second end region of the strap 104 relative to the mounting bracket 102. A threaded receiver 140 (e.g., a hex nut or a wing nut) may be received along the threaded shaft 138 to urge the attachment bracket 128 and strap 104 toward the receiving block 132 to tighten the strap 104 about the tank 12 of the water heater 10. With the strap 104 at least partially wrapped around the tank 12 and tightened to the mounting bracket 102, the second end region of the strap 104 extending beyond the attachment bracket 128 may be at least partially received or nested along the channel 108 of the bracket 102 to provide a clean installation of the bracing system 100.

The block 132 and the first end of the strap 104 are attached to the mounting bracket 102 via respective quick release pins 126 to allow for easy installation and to allow for easy adjustment along the mounting bracket 102 based on circumference of the tank 12 and the mounting position of the bracket 102 relative to the water heater 10. The recesses 118 of the mounting bracket 102 may be configured to accommodate differently sized water heaters. Further, the slots 116 of the mounting bracket 102 allow the mounting bracket 102 to be mounted to a variety of different surfaces (e.g., cinder block or brick walls, wooden framing, stucco or plaster, and the like) and assist the user in mounting the bracket 102 level. Thus, the bracing system 100 allows a user to quickly and easily brace the water heater 10 to the vertical wall structure. The system 100 may provide cost savings over current methods and ensures uniform application across different installation projects, leading to enhanced safety in water heater bracing.

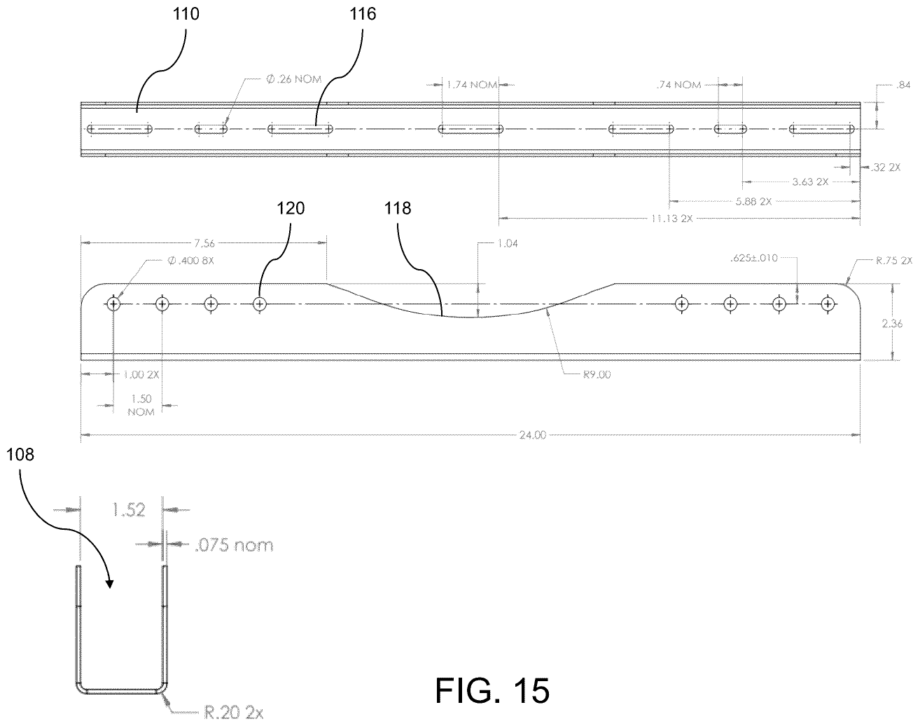

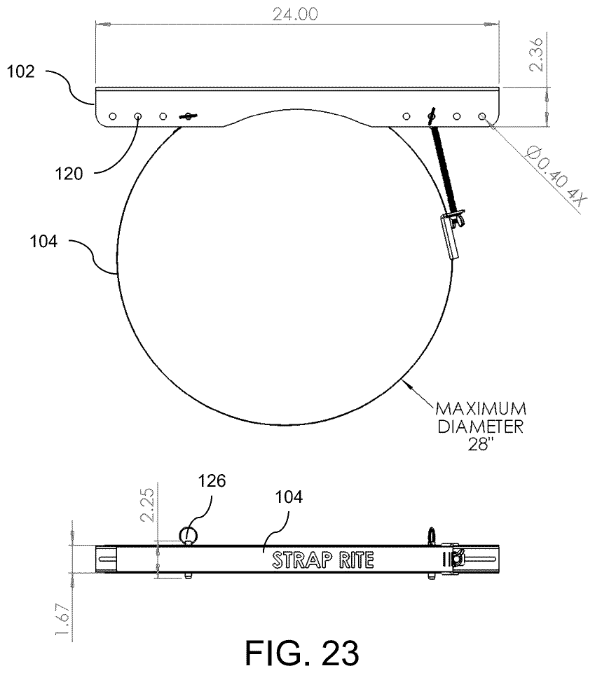

FIGS. 15, 17-19 and 23 include example dimensions of the bracing system 100. In the illustrated example, the mounting bracket 102 has a length measured along the longitudinal axis of 24 inches, a depth measured between the base 110 and the distal end of the legs 112, 114 of 2.36 inches, and a width measured between the first leg 112 and the second leg 114 of 1.52 inches. The first leg 112 and the second leg 114 may each have a width of 0.75 inches and a rounded corner between the respective legs and the base 110 may have a radius of 0.2 inches. The slots 116 formed through the base 110 may have a length of 0.74 inches or 1.74 inches or the like, and a width of 0.26 inches, with rounded ends of the slots 116 having a diameter of 0.26 inches. The holes 120 may have respective diameters of 0.4 inches and be spaced from one another by 1.5 inches. For example, there may be four holes 120 spaced from one another on either side of the cutout portion 118, beginning one inch from the edge of the mounting bracket 102. The cutout portion 118 may have a depth from the edge of the legs of 1.04 inches and a radius of 9 inches, such that a length of the mounting bracket 102 between the edge of the bracket and the edge of the cutout portion 118 is about 7.56 inches, or the cutout portion 118 may have a curvature radius of 8.75 inches or the like.

The block 132 of the tightening mechanism 106 is configured to fit within the channel 108 of the mounting bracket 102. For example, the block 132 may have a width of 0.5 inches, a height of 1.5 inches, and a depth of 1 inch. The diameter of the passageway 134 may be 0.375 inches and the threaded receiver 136 may have a major diameter of 0.375 inches, 16 threads per inch, a unified coarse thread, and a thread class of 2B. The threaded shaft 138 may have a length of six inches and a corresponding major diameter of 0.375 inches, 16 threads per inch, a unified coarse thread, and a thread class of 2A.

When the strap 104 is secured at the mounting bracket 102 and wrapped around the tank 12 of the water heater 10, the system 100 may be configured to accommodate a maximum diameter of the tank of 28 inches. For example, the strap 104 may have a length of 56 inches or 57.2 inches, a width of 1.5 inches, and a thickness of 0.036 inches. The slots 124 may have a width of 0.188 inches, a height of between about 0.688 inches and 0.708 inches, and rounded ends with a diameter of between about 0.188 inches and 0.208 inches. The slots 124 may be spaced by about 1.19 inches. The strap 104 may have chamfered corners with respective lengths of about 0.25 inches at 45 degree angles to the edges of the strap 104. The receiving portion 120 may be formed by folding a portion of the strap 104 over on itself to form a through hole having a diameter of about 0.5 inches, where the strap 104 joins to itself and forms an external radius of about 0.25 inches. The pins 126 may have a length of about 2.25 inches.

Although discussed herein as securing a water heater relative to a vertical wall structure, it should be understood that the bracing system may be suitable for securing other objects or devices. For example, the bracing system may be utilized to secure other objects relative to vertical wall structures, such as other types of tanks (e.g., feed silos or fermentation tanks), barrels (e.g., oil barrels or hazardous waste barrels), cans (e.g., garbage cans), and the like. Further, the bracing system may be utilized to secure objects relative to horizontal structures, such as to secure a horizontal tank (e.g., a propane tank) to a ground surface or to secure cargo relative to a bed of a trailer or truck. Optionally, the strap may be wrapped around a stationary structure (e.g., a column of a building) and the bracket may be attached to the object to be secured.

Changes and modifications in the specifically described embodiments can be carried out without departing from the principles of the invention, which is intended to be limited only by the scope of the appended claims, as interpreted according to the principles of patent law including the doctrine of equivalents.

1. A method for bracing a water heater to a vertical wall structure, the method comprising:
anchoring a mounting bracket to a vertical wall structure near a water heater;
securing a first end region of a strap to the mounting bracket;
wherein the strap comprises a second end region distal from the first end region, and wherein a slot is formed through the strap between the first end region and the second end region;
with the first end region of the strap secured to the mounting bracket, wrapping the strap at least partially about a tank of the water heater so that the tank is disposed between the strap and the mounting bracket;
wherein, with the strap wrapped at least partially about the tank of the water heater, a base portion of an attachment bracket is disposed between the strap and the tank of the water heater and a tab of the attachment bracket extends from the base portion and through the slot of the strap;
securing a first threaded receiver to the mounting bracket; and
with the strap wrapped at least partially about the tank of the water heater, and with the tab of the attachment bracket extending through the slot of the strap, and with a first end of a threaded shaft secured to the first threaded receiver at the mounting bracket, inserting a second end of the threaded shaft through the tab of the attachment bracket and fastening a second threaded receiver along the threaded shaft to secure the tank of the water heater between the strap and the mounting bracket.

2. The method of claim 1, wherein, with the tank of the water heater secured between the strap and the mounting bracket, at least a portion of the strap between the slot and the second end region of the strap is received along a channel of the mounting bracket.

3. The method of claim 1, wherein the first end region of the strap comprises a receiving portion, and wherein securing the first end region of the strap to the mounting bracket comprises inserting a pin through the mounting bracket and the receiving portion of the strap.

4. The method of claim 1, wherein securing the first threaded receiver to the mounting bracket comprises inserting a pin through the mounting bracket and the first threaded receiver.

5. The method of claim 1, wherein the mounting bracket comprises a cutout portion configured to at least partially receive the tank of the water heater.

6. The method of claim 5, wherein a shape of the cutout portion corresponds to an outer surface of the tank of the water heater.

7. The method of claim 1, wherein the second threaded receiver comprises a wing nut.

8. The method of claim 1, wherein a plurality of slots are formed through the strap, and wherein individual slots of the plurality of slots are spaced from one another along the strap between the first end region and the second end region.

9. The method of claim 8, wherein the tab of the attachment bracket extends through a selected individual slot of the plurality of slots.

10. The method of claim 1, further comprising adjusting the second threaded receiver along the threaded shaft to tighten the strap about the tank of the water heater.

11. A bracing system for securing a water heater to a vertical wall structure, the bracing system comprising:
a mounting bracket configured to be anchored to a vertical wall structure near a water heater;
a strap comprising a first end region and a second end region distal from the first end region, wherein a slot is formed through the strap between the first end region and the second end region, and wherein, with the mounting bracket anchored to the vertical wall structure, the first end region of the strap is secured to the mounting bracket;
a first threaded receiver, wherein, with the mounting bracket anchored to the vertical wall structure, the first threaded receiver is secured to the mounting bracket and spaced from the first end region of the strap;
an attachment bracket comprising a base portion and a tab extending from the base portion, wherein, with the mounting bracket anchored to the vertical wall structure, and with the strap wrapped at least partially about a tank of the water heater so that the tank is disposed between the strap and the mounting bracket, the base portion of the attachment bracket is disposed between the tank and the strap and the tab extends through the slot of the strap; and
a threaded shaft comprising a first end and a second end distal from the first end, wherein, with the mounting bracket anchored to the vertical wall structure, (i) the threaded shaft extends through the tab of the attachment bracket, (ii) the first end of the threaded shaft is received at the first threaded receiver and (iii) a second threaded receiver is received at the second end of the threaded shaft to secure the tank of the water heater between the strap and the mounting bracket.

12. The bracing system of claim 11, wherein, with the tank of the water heater secured between the strap and the mounting bracket, at least a portion of the strap between the slot and the second end region of the strap is received along a channel of the mounting bracket.

13. The bracing system of claim 11, wherein the first end region of the strap comprises a receiving portion, and wherein the first end region of the strap is secured to the mounting bracket via a pin extending through the mounting bracket and the receiving portion of the strap.

14. The bracing system of claim 11, wherein the first threaded receiver is secured to the mounting bracket via a pin extending through the mounting bracket and the first threaded receiver.

15. The bracing system of claim 11, wherein the mounting bracket comprises a cutout portion configured to at least partially receive the tank of the water heater when the tank of the water heater is secured between the strap and the mounting bracket.

16. The system of claim 15, wherein a shape of the cutout portion corresponds to an outer surface of the tank of the water heater.

17. The bracing system of claim 11, wherein the second threaded receiver comprises a wing nut.

18. The bracing system of claim 11, wherein a plurality of slots are formed through the strap, and wherein individual slots of the plurality of slots are spaced from one another along the strap between the first end region and the second end region.

19. The bracing system of claim 18, wherein the tab extends through a selected individual slot of the plurality of slots.

20. The bracing system of claim 11, wherein the second threaded receiver is adjusted along the threaded shaft to tighten the strap about the tank of the water heater.
